(19) United States
(12) Patent Application Publication
(10) Pub. No.: US 2014/0072188 A1
(43) Pub. Date: Mar. 13, 2014

(54) FINGERPRINT IDENTIFICATION AND VERIFICATION SYSTEM AND METHOD THEREOF

(71) Applicant: EGIS TECHNOLOGY INC., TAIPEI CITY (TW)

(72) Inventors: CHUN-YEH LIU, TAIPEI CITY (TW); YUAN-LIN CHIANG, TAIPEI CITY (TW); JUNG-CHIEN LEE, TAIPEI CITY (TW)

(21) Appl. No.: 13/943,358

(22) Filed: Jul. 16, 2013

Related U.S. Application Data
(60) Provisional application No. 61/698,112, filed on Sep. 7, 2012.

(51) Int. Cl. G06K 9/00

(52) U.S. Cl. CPC G06K 9/00073
USPC 382/125

(57) ABSTRACT

In a fingerprint identification and verification system and its method, the system includes a Bluetooth fingerprint device, an application device, a fingerprint identification server, and an application control device. The Bluetooth fingerprint device captures a fingerprint image, extracts the minutiae data from the fingerprint image, and sends the minutiae data to the application device. The application device transmits the minutiae data and a verification request to the application control device and the application control device transmits the minutiae data to the fingerprint identification server to perform the fingerprint identification process. The fingerprint identification server sends a verification result on which the application control device depends to accept or refuse the verification request from the application device. As a result, the speed of the user's identification process can be increased by using the Bluetooth fingerprint device to derive the minutiae data.

### CROSS-REFERENCE TO RELATED APPLICATION

This application claims the benefit of U.S. Patent Application No. 61/698,112, filed on Sep. 7, 2012, in the United States Patent and Trademark Office, the disclosure of which is incorporated herein in its entirety by reference.

### BACKGROUND OF THE INVENTION

1. Field of the Invention

The present invention relates to a fingerprint identification and verification system and a method thereof, and more particularly to the fingerprint identification and verification system and method with a Bluetooth fingerprint device.

2. Description of the Related Art

In recent years, biological identification technology becomes increasingly more mature, and different biological features can be used for identifying users. Since the recognition rate and accuracy of the fingerprint identification technology are better than those of other biological feature identification technologies, fingerprint identification and verification are used extensively in various different areas.

The fingerprint identification and verification technology detects a user's fingerprint image, captures a unique minutiae data from the fingerprint image, and saves the minutiae data as a template. Thereafter, the user presses or slides the finger such that a fingerprint is captured and compared with the template. If the two are matched, then the user's identity is verified.

At present, the data access of websites adopts the fingerprint identification and verification technology to confirm a user's identity. If the user wants to visit these websites, it is necessary to input the user's fingerprint image through a near-end input device. The present near-end input device generally uses a fingerprint device for transmitting a fingerprint image to a computer host via cable transmission. For example, a remote identification and verification system using biological features was disclosed in R.O.C. Pat. No. 525096, wherein the remote identification and verification system uses the biological features to capture a fingerprint image by a local computer host, produces the minutiae data, and transmits the data to a remote identification device. The remote identification device is connected to a fingerprint database to access the minutiae data stored in the fingerprint database to perform identification and verification. As the number of network users increases, this way of accessing the minutiae data from the fingerprint database for the identification and verification takes much identification and verification time. As portable devices become increasingly more popular, using the portable electronic devices to input the minutiae data has become a trend in addition to using the computer host to input the minutiae data.

For example, many portable electronic devices such as Smartphones and tablet PCs have a network connection function, but they are generally not disposed with a fingerprint input function. If the fingerprint input function is added, then related suppliers and manufactures will require special projects to handle the manufacture of new mobile phones and tablet PCs. That is the main reason why present existing portable electronic devices usually are not disposed with the fingerprint input function.

In case another conventional fingerprint device is used to transmit the minutiae data to the portable electronic device, since there are various brands of portable electronic devices, the installation of an additional driver program of the fingerprint device is required for a normal operation when the electronic devices of different brands are connected to the conventional fingerprint device.

### SUMMARY OF THE INVENTION

In view of the aforementioned problems of the prior art, it is a primary objective of the present invention to provide a fingerprint identification and verification system and its method to overcome the problem of the prior art that requires the installation of an additional driver program in order to input a finger image from an external fingerprint device due to the fact that a portable electronic device seldom comes with the fingerprint input function.

To achieve the aforementioned objective, the present invention provides a fingerprint identification and verification system, comprising: a Bluetooth fingerprint device, an application device, a fingerprint identification server, and an application control device. The Bluetooth fingerprint device comprises a processing unit and a fingerprint image capturing unit, and the processing unit processes a fingerprint image captured by the fingerprint image capturing unit to capture the minutiae data of the fingerprint image and produces the minutiae data. The application device has an application program and receives the minutiae data through the Bluetooth fingerprint device and sends a verification request. The verification request includes the minutiae data and a verification request from the application program. The fingerprint identification server includes a random access memory unit for storing N fingerprint template data, such that when the fingerprint identification server receives the minutiae data of the verification feature request, the fingerprint identification server compares the minutiae data with one of the N fingerprint template data to determine whether or not the two are matched, and sends a verification result, wherein N is greater than or equal to 1. The application control device receives the verification result and accepts or refuses the verification request of the application program according to the verification result.

Preferably, the fingerprint identification and verification system further comprises a data storage device electrically coupled to the application control device and backs up the N fingerprint template data.

Preferably, the fingerprint identification and verification system further comprises a cable-transmission fingerprint device, and the cable-transmission fingerprint device further comprises a fingerprint image capturing unit for capturing at least one fingerprint image and transmitting the at least one fingerprint image to the application device, wherein the application device receives the at least one fingerprint image and converts the at least one fingerprint image into the (N+1)th fingerprint template data, and the fingerprint identification server receives the (N+1)th fingerprint template data and registers the (N+1)th fingerprint template data to the random access memory unit.

Preferably, the application control device receives the at least one fingerprint image and the (N+1)th fingerprint template data corresponding to the at least one fingerprint image and backs up the at least one fingerprint image and the (N+1)th fingerprint template data corresponding to the at least one fingerprint image to the data storage device.

Preferably, the fingerprint identification and verification system further comprises a cable-transmission fingerprint device, and the cable-transmission fingerprint device further comprises a processing unit and a fingerprint image capturing unit. The processing unit is used to process a fingerprint image captured by the fingerprint image capturing unit to produce the minutiae data of the fingerprint image. The minutiae data is transmitted to the application device afterwards.

To achieve another objective, the present invention further provides a fingerprint identification and verification method comprising the steps of: using a Bluetooth fingerprint device to capture a fingerprint image and producing the minutiae data, wherein the Bluetooth fingerprint device comprises a processing unit and a fingerprint image capturing unit. The processing unit processes the fingerprint image captured by the fingerprint image capturing unit to derive the minutiae data of the fingerprint image, and send the minutiae data; using an application device to receive the minutiae data through the Bluetooth fingerprint device and send a verification request, wherein the application device has an application program. The verification request includes the minutiae data and a verification request from the application program; using a fingerprint identification server to receive the minutiae data in the verification feature request, and using a random access memory unit of the fingerprint identification server to store N fingerprint template data, and using the fingerprint identification server to compare the minutiae data with one of the N fingerprint template data to determine whether or not the two are matched and send a verification result, wherein N is greater than or equal to 1; and using an application control device to receive the verification result and accept or refuse the verification request from the application program according to the verification result.

Preferably, the fingerprint identification and verification method further comprises the step of using a data storage device to back up the N fingerprint template data.

Preferably, the fingerprint identification and verification method further comprises the steps of using a cable-transmission fingerprint device to capture at least one fingerprint image; and using the application device to receive the at least one fingerprint image and convert the at least one fingerprint image into the (N+1)th fingerprint template data. Using the fingerprint identification server to receive the (N+1)th fingerprint template data, and registering the (N+1)th fingerprint template data to the random access memory unit.

Preferably, the fingerprint identification and verification method further comprises the step of using the application control device to receive the at least one fingerprint image and the (N+1)th fingerprint template data corresponding to the at least one fingerprint image, and backing up the at least one fingerprint image and the (N+1)th fingerprint template data corresponding to the at least one fingerprint image to the data storage device.

Preferably, the fingerprint identification and verification method further comprises the step of using a cable-transmission fingerprint device to capture a fingerprint image and produce a minutiae data, wherein the cable-transmission fingerprint device comprises a processing unit and a fingerprint image capturing unit. The processing unit is used to process a fingerprint image captured by the fingerprint image capturing unit to derive the minutiae data of the fingerprint image, produce the minutiae data, and transmit the minutiae data to the application device.

In summation, the fingerprint identification and verification system and method of the present invention have one or more of the following advantages:

(1) With the Bluetooth transmission function of the Bluetooth fingerprint device, the fingerprint identification and verification system and method of the present invention can utilize the Bluetooth fingerprint device and the application device to transmit the minutiae data without requiring the installation of an additional driver program.

(2) Since the data transmitted by the Bluetooth fingerprint device is the minutiae data instead of the fingerprint image, the time needed to transmit the minutiae data is less than the time needed to transmit the fingerprint image. In addition, the fingerprint identification server accesses the fingerprint template data in the random access memory unit directly, so that the fingerprint data retrieval speed of the present invention is faster than the data retrieval speed of the conventional method of retrieving fingerprint template data from the fingerprint database. Therefore, the identity verification speed of the fingerprint identification and verification system has been improved by using the present invention.

### BRIEF DESCRIPTION OF THE DRAWINGS

FIG. 1 is a schematic block diagram of a fingerprint identification and verification system of a first preferred embodiment of the present invention;

FIG. 2 is a system block diagram of a Bluetooth fingerprint device of a fingerprint identification and verification system of the first preferred embodiment of the present invention;

FIG. 3 is a first schematic view of capturing a minutiae data from a Bluetooth fingerprint device of the present invention;

FIG. 4 is a second schematic view of capturing a minutiae data from a Bluetooth fingerprint device of the present invention;

FIG. 5 is a schematic block diagram of a fingerprint identification and verification system of a second preferred embodiment of the present invention;

FIG. 6 is a software block diagram of a fingerprint identification and verification system of the second preferred embodiment of the present invention;

FIG. 7 is a flow chart of comparing fingerprints by a fingerprint identification and verification system of the present invention; and

FIG. 8 is a flow chart of registering a fingerprint by a fingerprint identification and verification system of the present invention.

### DETAILED DESCRIPTION OF THE PREFERRED EMBODIMENTS

The technical content of the present invention will become apparent by the detailed description of the following embodiments and the illustration of related drawings as follows.

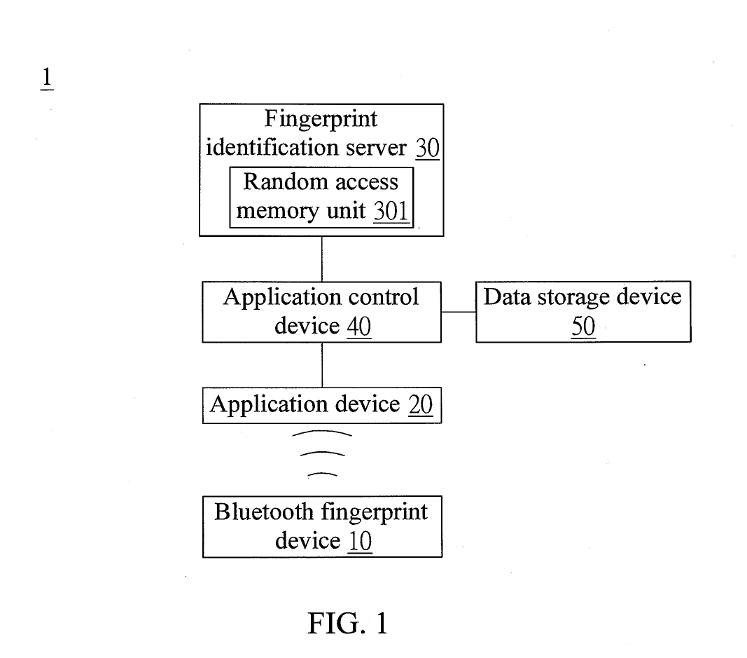

With reference to FIG. 1, which is a schematic block diagram of a fingerprint identification and verification system of the first preferred embodiment of the present invention, the fingerprint identification and verification system 1 comprises a Bluetooth fingerprint device 10, an application device 20, a fingerprint identification server 30 and an application control device 40.

The Bluetooth fingerprint device 10 transmits the minutiae data to the application device 20, wherein the application device 20 of this preferred embodiment includes but is not limited to a Smartphone. In other preferred embodiments of the present invention, the application device 20 can be a tablet PC or any electronic device with a Bluetooth transmission function.

The application device 20 has an application program. When a user runs the application program of the application device 20, the user must go through an identity verification before accessing the application information from a network corresponding to the application program. The application program will request the user to press or slide a fingerprint onto the Bluetooth fingerprint device 10 for a verification request. The application device 20 combines the verification request and the minutiae data into a verification request, and transmits the verification request to the application control device 40.

The application control device 40 receives the verification request from the application device 20 and transmits the minutiae data to the fingerprint identification server 30 to perform fingerprint comparison.

The fingerprint identification server 30 further includes a random access memory unit 301 for pre-storing a plurality of fingerprint template data. The fingerprint template data is the minutiae data registered by a user using the application program of the application device 20 for the first time. When the fingerprint identification server 30 receives the minutiae data in the verification request, the minutiae data are compared with the fingerprint template data stored in the random access memory unit 301. In other words, the fingerprint identification server 30 compares the minutiae data in the verification request with one of the plurality of fingerprint template data stored in the random access memory unit 301 to determine whether the two are matched, producing a verification result to the application control device 40. If the minutiae data is matched with one of the plurality of fingerprint template data, the verification result will include the information of a successful comparison; and if the minutiae data is not matched with any of the fingerprint template data, the verification result will include information of a failed comparison.

The application control device 40 receives a verification result of the fingerprint identification server 30 and accepts or refuses the verification request from the application program of the application device 20 according to the verification result. If the minutiae data is matched with one of the plurality of fingerprint template data, then the user can access the corresponding application data by the application program via the network. If the minutiae data is not matched with any of the fingerprint template data, then the user can use the Bluetooth fingerprint device to input the fingerprint minutiae data and perform the identity verification again. If the verification still fails, then the user will be refused to enter into the application program to access data, or the user will have a partial data access right only.

It is noteworthy that the Bluetooth fingerprint device 10 of this preferred embodiment captures the user's fingerprint image to process and capture the minutiae data of the fingerprint image and transmits the minutiae data to the application device 20. The Bluetooth fingerprint device 10 transmits the minutiae data directly, so that the fingerprint device of the present invention can shorten the transmission time of the fingerprint data when compared with the conventional device transmitting the fingerprint images. Since the Bluetooth fingerprint device 10 and the application device 20 can communicate through the universal Bluetooth transmission protocol, it is not necessary to install an additional driver program in order to establish the communication between the Bluetooth fingerprint device 10 and the application device 20.

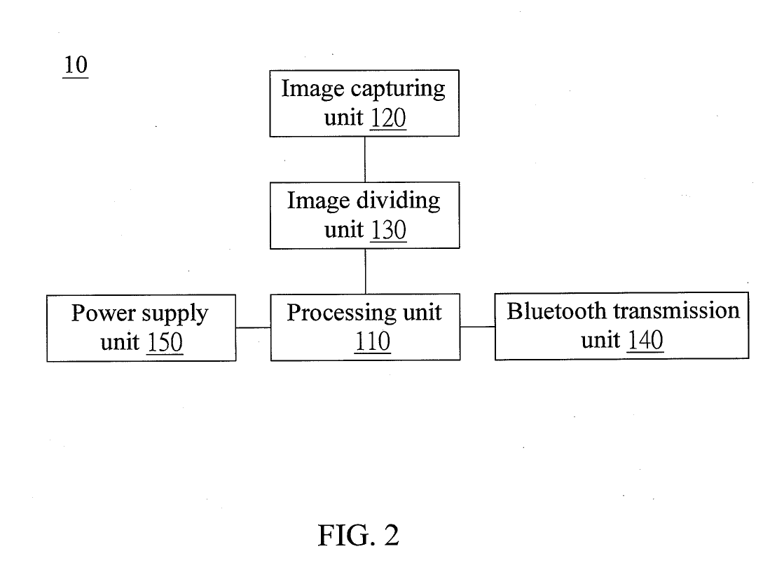

With reference to FIG. 2, which is a system block diagram of a Bluetooth fingerprint device of a fingerprint identification and verification system of the first preferred embodiment of the present invention, the Bluetooth fingerprint device 10 comprises a processing unit 110, an image capturing unit 120, an image dividing unit 130, a Bluetooth transmission unit 140 and a power supply unit 150. In FIG. 2, the image capturing unit 120 captures a fingerprint image from a user, and the image dividing unit 130 divides the fingerprint image into a plurality of sub-images, and the processing unit 110 processes each sub-image to derive a minutiae data of each fingerprint image. Thereafter, the processing unit 110 assembles the minutiae data of each sub-image into a whole copy of a minutiae data of the fingerprint image and transmits the minutiae data to the Bluetooth transmission unit 140. The power supply unit 150 supplies electric power required for the operation of each unit.

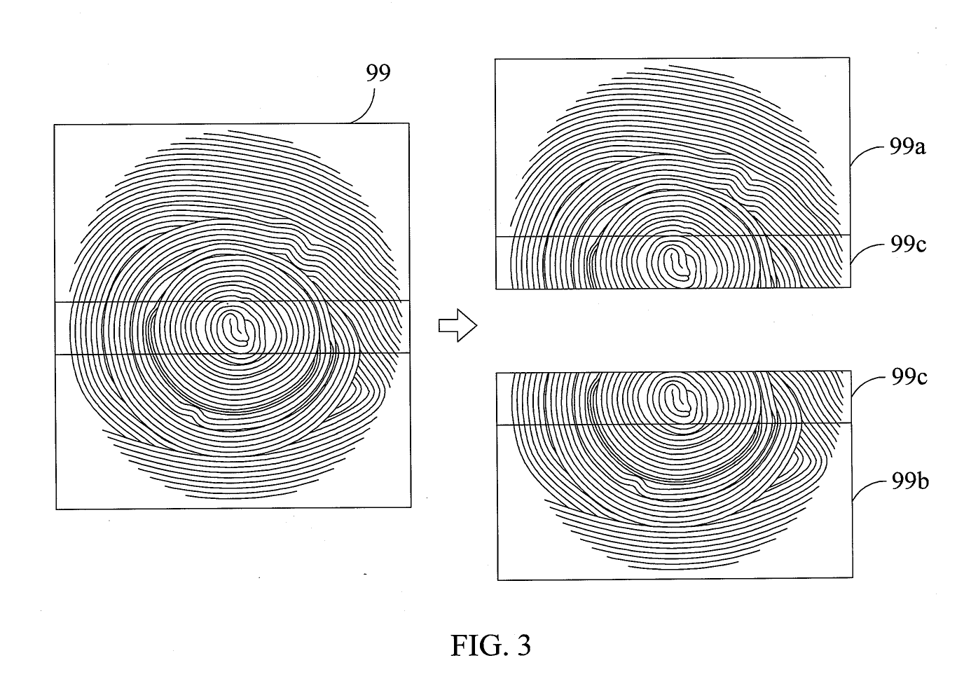

In an example as shown in FIG. 3, the image dividing unit 130 of this preferred embodiment is provided to divide the original fingerprint image 99 into an upper fingerprint image 99a and a lower fingerprint image 99b. The divided upper fingerprint image 99a and the lower fingerprint image 99b have a mutually overlapped fingerprint image 99c.

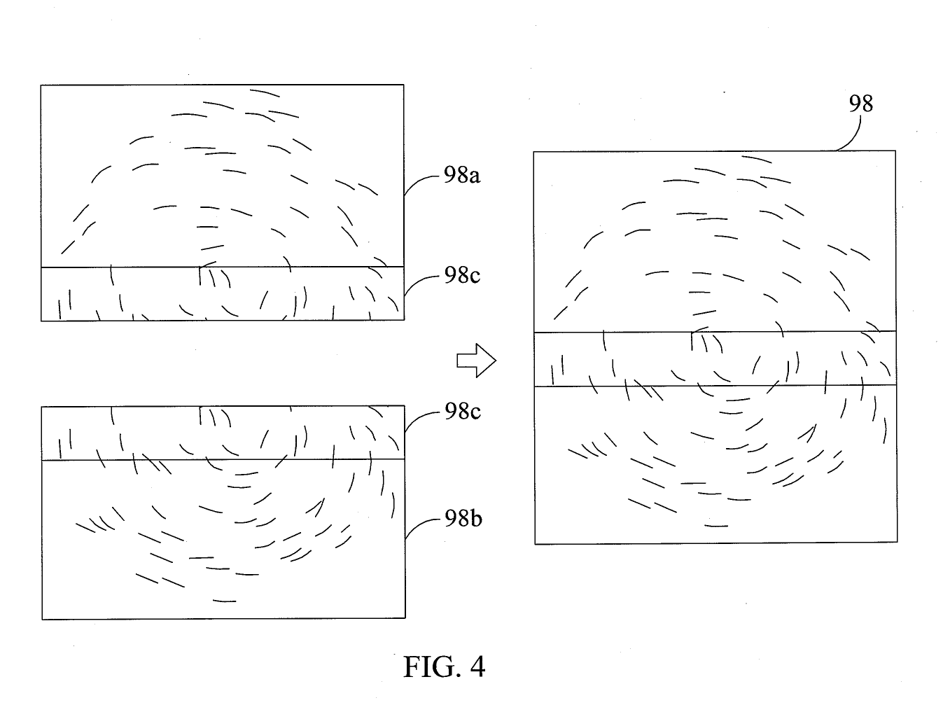

In FIG. 4, the processing unit 110 captures the minutiae data 98a, 98b from the upper fingerprint image 99a and the lower fingerprint image 99b respectively. Since the upper fingerprint image 99a and the lower fingerprint image 99b have the minutiae data 98c of the mutually overlapped fingerprint images 99c, the processing unit 110 can use the minutiae data 98c of the mutually overlapped fingerprint images 99c as a reference for combining the minutiae data 98a of the upper fingerprint image 99a and the minutiae data 98b of the lower fingerprint image 99b into the minutiae data 98 from its corresponding fingerprint image 99. The fingerprint image is divided into two sub-images in this preferred embodiment for the purpose of illustrating the present invention, but the present invention is not limited to such arrangement only.

In the fingerprint identification and verification system of this preferred embodiment, a user can use the Bluetooth device to connect the portable electronic device with a Bluetooth transmission via a cable connection without requiring the installation of an additional driver program. In addition, the Bluetooth portable device manufacturers no longer require additional manufacturing cost to equip the portable electronic device with a fingerprint device.

In addition, the fingerprint identification and verification system of this preferred embodiment stores the fingerprint template data in the random access memory unit 301 of the fingerprint identification server 30, so that the fingerprint identification server has a faster comparison speed than other conventional systems that store the fingerprint template data in an external fingerprint database. When the fingerprint identification and verification system of this preferred embodiment is used and the identity verification is performed via the Bluetooth fingerprint device, the user can obtain the identity verification result quickly.

It is noteworthy that the Bluetooth fingerprint device of the present invention is not limited to the aforementioned arrangement, but the Bluetooth fingerprint device of another preferred embodiment can further comprise a comparing unit, so that the user can compare the minutiae data in the Bluetooth fingerprint device directly. The comparison result will be transmitted to an electronic device via the Bluetooth transmission without the need of transmitting the minutiae data.

For example, when a certain application program or electronic device only allows a limited number of users, the user's minutiae data is pre-stored in the Bluetooth fingerprint device. When the comparing unit in the Bluetooth fingerprint device is used to access the application program or electronic device at a later time, the identity comparison will be preformed. If the comparison is successful, then the application program or electronic device will transmit the verification information to an end device to request for data access without the need of transmitting the minutiae data.

In FIG. 1, the fingerprint identification and verification system of this preferred embodiment further comprises a data storage device 50 electrically coupled to the application control device 40. The data storage device 50 is provided to back up a plurality of fingerprint template data or the fingerprint images corresponding to the plurality of fingerprint template data stored in the random access memory unit 301.

More specifically, when a user wants to register new fingerprint data, the user can press the fingerprint and transmit the desired registering minutiae data to the application device 20 through the Bluetooth fingerprint device 10 in this preferred embodiment. The application device 20 with the application program transmits a registration request to the application control device 40. The registration request comprises the user's new registered minutiae data. After the application control device 40 has received the registration request, the desired registering minutiae data will be uploaded to the random access memory unit 301 of the fingerprint identification server 30 to serve as one of the fingerprint template data pre-stored in the random access memory unit 301, and the application control device 40 will back up the desired registering minutiae data to the data storage device 50 at the same time.

It is noteworthy that when the user wants to register new fingerprint data in the present invention, the user also can use a fingerprint device other than the Bluetooth fingerprint device 10 as a medium for imputing the fingerprint. For example, another preferred embodiment of the present invention also can use a universal serial bus (USB) fingerprint device or any other cable fingerprint device to input the fingerprint image. Now, the application control device 40 will back up the fingerprint image data to the data storage device 50, and will use a software development kit (SDK) of the fingerprint file conversion to convert the fingerprint image stored in the data storage device 50 into a specific minutiae data format for the fingerprint identification and verification system of the present invention. The application control device 40 uploads the converted minutiae data to the random access memory unit 301 of the fingerprint identification server 30 to serve as one of the pre-stored fingerprint template data.

When a user registers new fingerprint data, the user can selectively input one or a plurality of fingerprint images. Therefore, the fingerprint image data stored in the data storage device 50 through each finger of the corresponding user can be one or more diagrams.

In the fingerprint identification and verification system of this preferred embodiment, the fingerprint template data is stored in the random access memory unit of the fingerprint identification server, so that the comparison speed is faster than the speed of the conventional fingerprint comparison method that accesses the fingerprint template data from an external database.

Since this preferred embodiment can use the data storage device to back up the fingerprint image or the minutiae data corresponding to the fingerprint template data, this preferred embodiment can also store the fingerprint image captured by other types of fingerprint devices. A fingerprint file conversion software development kit is used to convert the fingerprint image into a minutiae data format for the fingerprint identification and verification system of this preferred embodiment.

More specifically, the user may use a large quantity of fingerprint diagrams collected by other fingerprint devices for some reasons in the practical application of the present invention. If the minutiae data format adopted by other fingerprint devices is different from that of the present invention, the minutiae data may not be able to be compared. Now, the software development kit of the fingerprint file conversion of the present invention can be used to adjust the size and resolution of the fingerprint image, optimize the zoom ratio, and produce the corresponding minutiae data. The minutiae data format of the fingerprint identification and verification system of the present invention must be matched before fingerprint comparison can be performed.

Therefore, the fingerprint identification and verification system of the present invention can be merged into existing systems for its practical operation, and the fingerprint identification and verification system of the present invention can be used to obtain the identity verification result quickly.

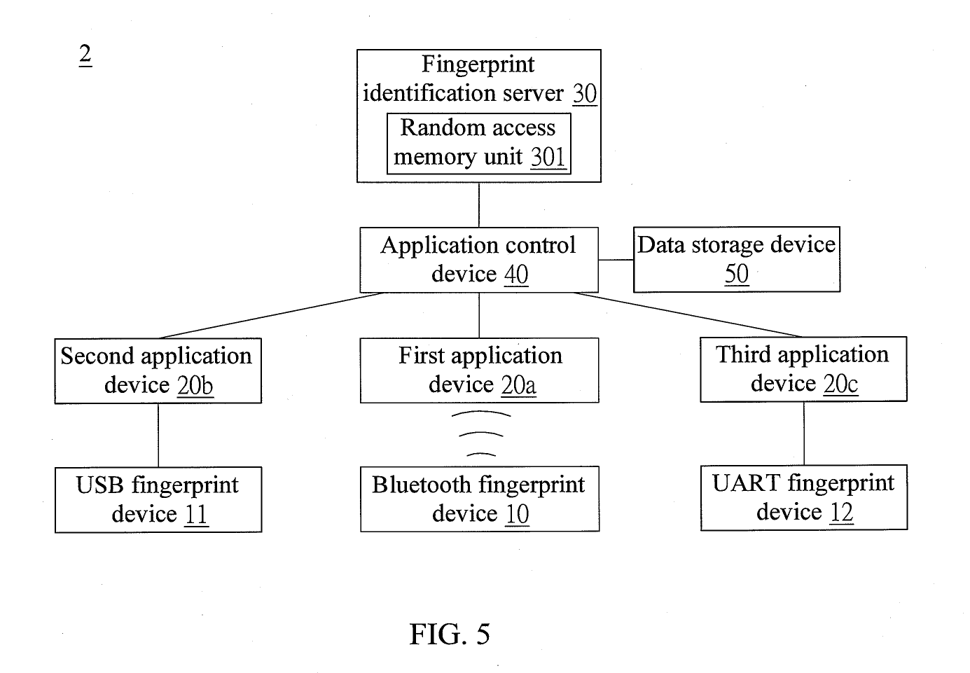

With reference to FIG. 5, which is a schematic block diagram of a fingerprint identification and verification system of the second preferred embodiment of the present invention, the fingerprint identification and verification system 2 comprises a Bluetooth fingerprint device 10, a USB fingerprint device 11, a universal asynchronous receiver/transmitter (UART) fingerprint device 12, a first application device 20a, a second application device 20b, a third application device 20c, an application control device 40, a fingerprint identification server 30, and a data storage device 50.

In FIG. 5, the Bluetooth fingerprint device 10 is connected to the first application device 20a, and the first application device of this preferred embodiment is a Smartphone including but not limited to iPhone, Samsung Galaxy Note, and HTC One. The USB fingerprint device 11 is connected to the second application device 20b, and the second application device 20b is a personal computer or a notebook computer. The UART fingerprint device 12 is connected to the third application device 20c, and the third application device 20c is a general feature phone such as Nokia C2-06 and LG KU380.

The fingerprint image capturing unit of the USB fingerprint device 11 captures a user's fingerprint image and transmits the fingerprint image to the second application device 20b, wherein the second application device 20b is a personal computer, so that the second application device 20b can process the fingerprint image through a minutiae data capturing kit of the computer and capture the corresponding minutiae data. The second application device 20b is provided to send a verification request to the application control device 40. The verification request includes a verification request from an application program of the second application device 20b and the minutiae data. After the application control device 40 received the verification request of the second application device 20b, the following operation is similar to that of the first preferred embodiment, and thus will not be repeated.

It is noteworthy that the user can also use the USB fingerprint device to register fingerprints. More specifically, when the user uses the USB fingerprint device to register fingerprints, the user collects and transmits one or more fingerprint images to the second application device 20b. The second application device 20b converts one or more fingerprint images of the user into corresponding fingerprint template data of the user and transmits the fingerprint template data and one or more fingerprint images of the user to the application control device 40. The application control device 40 receives the one or more fingerprint images and the fingerprint template data and transmits the fingerprint image to the data storage device 50 to serve as a copy. In the meantime, the fingerprint template data is transmitted to the fingerprint identification server 30, and the fingerprint identification server 30 registers such new fingerprint template data to the random access memory unit 301.

When the user needs to register a large quantity of new fingerprint template data, the second application device 20b and the USB fingerprint device 11 of this preferred embodiment can collect the fingerprint online or offline. In other words, if the second application device 20b is not connected to the application control device 40 or the fingerprint identification server 30, the second application device 20b and the USB fingerprint device 11 of this preferred embodiment can also perform the fingerprint collection. After the second application device 20b is connected to the application control device 40, the newly collected fingerprint images and their corresponding fingerprint template data are uploaded to the application control device 40 in batches. It is noteworthy that the aforementioned application of registering the new fingerprint template data by the user is usually adopted by large public service systems.

The UART fingerprint device 12 is connected to the third application device 20c, and the UART fingerprint device 12 further includes a processing unit and a fingerprint image capturing unit, wherein the processing unit is provided to process the fingerprint image captured by the fingerprint image capturing unit which captures the minutiae data of the fingerprint image and to transmit the minutiae data to the third application device 20c. The third application device 20c is provided to send a verification request to the application control device 40. The verification request includes a verification request from the application program of the third application device 20c and the minutiae data. After the application control device 40 received the verification request of the third application device 20c, the following operation is similar to that of the first preferred embodiment, and thus will not be repeated.

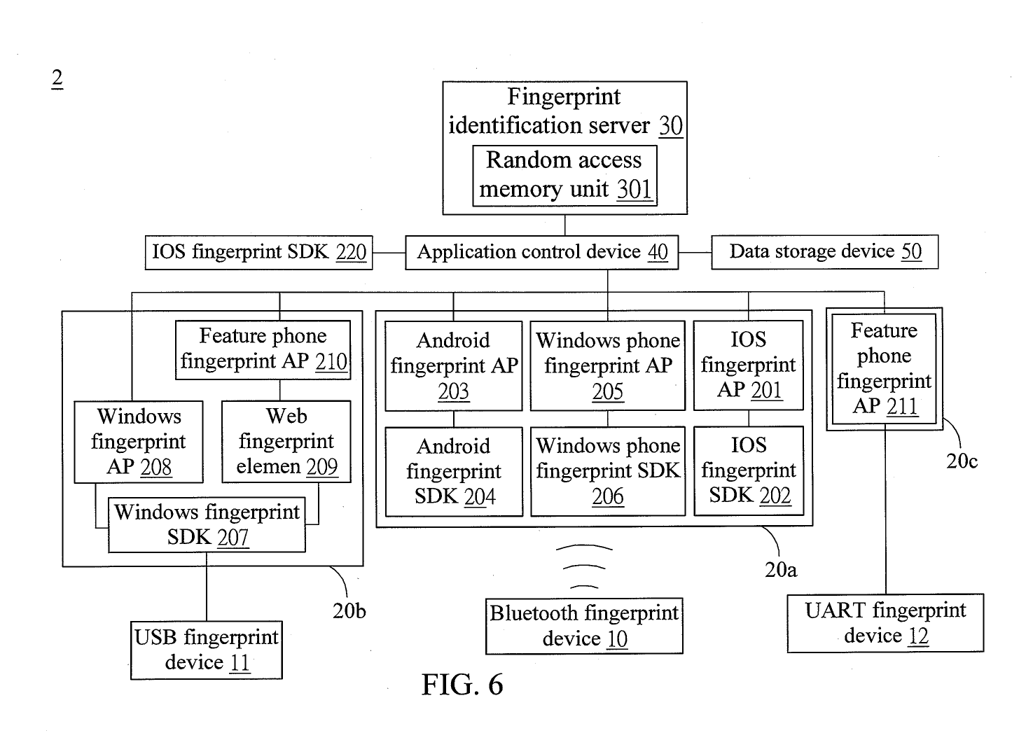

With reference to FIG. 6, which is a software block diagram of a fingerprint identification and verification system of the second preferred embodiment of the present invention, the fingerprint identification and verification system 2 comprises a Bluetooth fingerprint device 10, a USB fingerprint device 11, a UART fingerprint device 12, a first application device 20a, a second application device 20b, a third application device 20c, an application control device 40, a fingerprint identification server 30, and a data storage device 50.

The USB fingerprint device 11 and the UART fingerprint device 12 are connected to the second application device 20b and the third application device 20c, respectively. The Bluetooth fingerprint device 10 is connected with the first application device 20a via Bluetooth wireless transmission.

In this preferred embodiment, the first application device 20a can be any type of Smartphone. If the first application device 20a is an IOS Smartphone such as iPhone, then the first application device 20a can be installed with an IOS fingerprint software development kit 201. The IOS fingerprint software development kit 201 is used to package the complicated Bluetooth communication and fingerprint collection procedure into a modular kit, so that the engineers familiar with the IOS can develop an IOS fingerprint related application program 202 quickly based on the IOS fingerprint software development kit 201. After the IOS application program 202 has obtained the minutiae data through the IOS fingerprint software development kit 201, the application control device 40 requests the fingerprint identification server 30 to perform a fingerprint comparison.

If the first application device 20a is an Android Smartphone such as HTC Hero, then the first application device 20a can be installed with an Android fingerprint software development kit 203. The Android fingerprint software development kit 203 is used to package the complicated Bluetooth communication and fingerprint collection procedure into a modular kit so that the engineers familiar with the Android system can develop the fingerprint related Android application program 204 based on the Android fingerprint software development kit 203. After the Android application program 204 has obtained the minutiae data through the Android fingerprint software development kit 203, the application control device 40 requests the fingerprint identification server 30 to perform a fingerprint comparison.

If the first application device 20a is a Windows Smartphone such as Nokia Lumia 820, then the first application device 20a can be installed with a Windows Phone fingerprint software development kit 205. The Windows Phone fingerprint software development kit 205 is used to package the complicated Bluetooth communication and fingerprint collection procedure into a modular kit, so that the engineers familiar with the Windows Phone can develop a fingerprint related Windows Phone application program 206 based on the Windows Phone fingerprint software development kit 205. After the Windows Phone application program 206 has obtained the minutiae data through the Windows Phone fingerprint software development kit 203, the application control device 40 requests the fingerprint identification server 30 to perform a fingerprint comparison.

In this preferred embodiment, the second application device 20b is a desktop computer or a notebook computer. If the second application device 20b is a computer bundled with the Windows operating system, then the second application device 20b can be installed with a Windows fingerprint software development kit 207, so that the engineers familiar with the Windows system can develop a fingerprint related Windows application program 208 based on the Windows fingerprint software development kit 207. After the Windows application program 208 has obtained the minutiae data through the Windows fingerprint software development kit 207, the application control device 40 requests the fingerprint identification server 30 to perform a fingerprint comparison, but this preferred embodiment is not limited to the aforementioned arrangement only. In another preferred embodiment of the present invention, the engineers familiar with the Windows system can develop a fingerprint related Web fingerprint element 209 based on the Windows fingerprint software development kit 207. After the Web fingerprint element 209 obtained the minutiae data through the Windows fingerprint software development kit 207, a verification request including the minutiae data is transmitted through an IE browser 210 to the application control device 40.

The third application device 20c can be a general feature phone such as Nokia C2-06. The third application device 20c includes a feature phone fingerprint application program 211 to receive the minutiae data transmitted from the UART fingerprint device 12, and the application control device 40 requests the fingerprint identification server 30 to perform a fingerprint comparison.

The application control device 40 is the control center of the fingerprint identification and verification system of this preferred embodiment, and the application control device 40 is connected to the data storage device 50, the fingerprint identification server 30, the first application device 20a, the second application device 20b, and the third application device 20c. When the application control device 40 obtains the desired verifying fingerprint from the first application device 20a, the second application device 20b, or the third application device 20c, the application control device requests the fingerprint identification server 30 to compare the fingerprint with the plurality of fingerprint template data stored in the random access memory unit 301 and to send a corresponding response to the first application device 20a, the second application device 20b or the third application device 20c with the comparison result. If the compared result is positive, then the first application device 20a, the second application device 20b or the third application device 20c will be allowed to enter the application system and access data.

In addition, if the application control device 40 receives the desired registering new fingerprint template data and at least one of their corresponding fingerprint images from the first application device 20a, the second application device 20b or the third application device 20c, the at least one fingerprint image can be backed up to the data storage device 50 and the fingerprint template data can be uploaded to the fingerprint identification server 30. The fingerprint identification server 30 registers the new fingerprint template data to the random access memory unit 301.

It is noteworthy that the fingerprint identification and verification system of this preferred embodiment further comprises a fingerprint file conversion software development kit 220. When the fingerprint image data of the data storage device 50 are converted into the fingerprint template data of a specific format, the fingerprint file conversion software development kit 220 is used to adjust the size and resolution of the fingerprint image and produce the corresponding minutiae data. The minutiae data format must be matched with the format of the fingerprint identification and verification system of the present invention before the fingerprint comparison can be performed.

With the aforementioned software architecture, the fingerprint identification and verification system of the present invention can use the fingerprint file conversion software development kit directly to convert the minutiae data format into the format corresponding to the fingerprint image captured by other fingerprint devices, so that the present invention and existing systems are highly compatible. In addition, the present invention access the fingerprint template data from the random access memory unit through the fingerprint identification server directly for the comparison of the fingerprint image with the fingerprint template data without additional access of data from the data storage device, which increases the comparison speed. Furthermore, the Bluetooth fingerprint device of the present invention can be connected to any Bluetooth portable electronic product conveniently, and the image dividing unit and the processing module of the Bluetooth fingerprint device can be used to retrieve a minutiae data directly with limited hardware resources of the Bluetooth fingerprint device. Since the volume of the minutiae data is smaller than that of the fingerprint images, the Bluetooth fingerprint device can be used to transmit the minutiae data, and the minutiae data can be transmitted to the application device quickly. Therefore, the fingerprint identification and verification system of the present invention allows users to perform identity verification quickly.

The following flow chart is provided to illustrate the method of adding a template data to the fingerprint identification and verification system and the method of fingerprint comparison of the present invention.

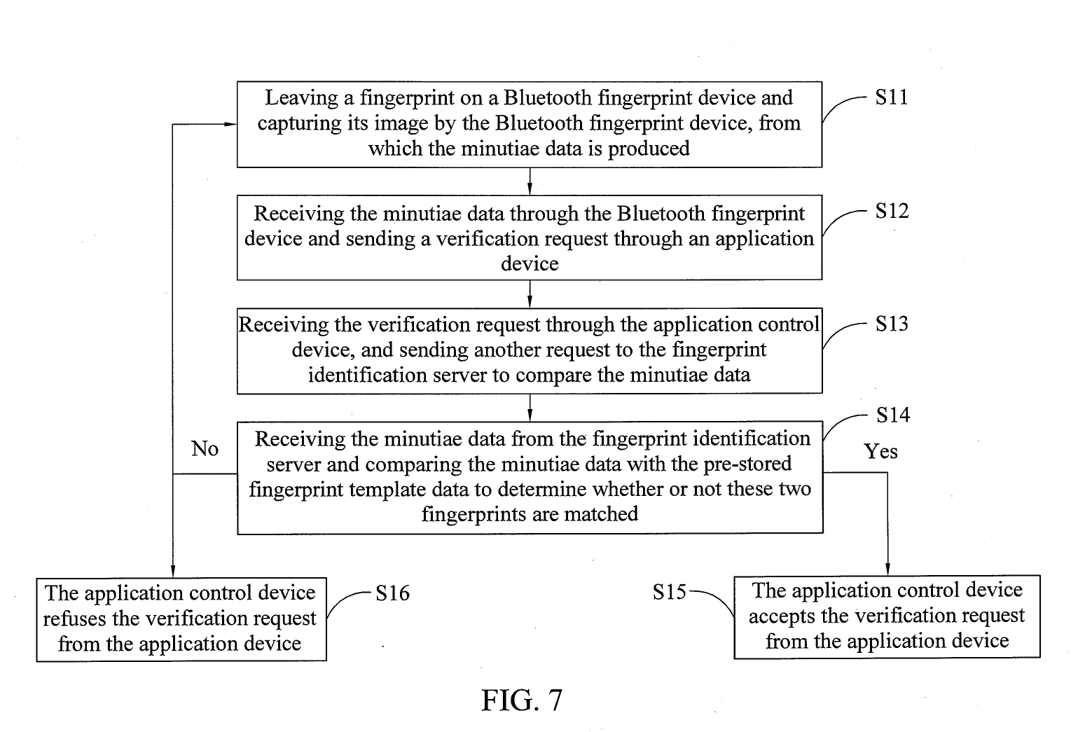

With reference to FIG. 7, which is a flow chart of a fingerprint comparison in a fingerprint identification and verification system of the present invention, the fingerprint comparison comprises the following steps:

S11: Leaving a fingerprint on a Bluetooth fingerprint device and capturing its image by the Bluetooth fingerprint device, from which the minutiae data is produced.

The Bluetooth fingerprint device or the cable-transmission fingerprint device comprises a processing unit and a fingerprint image capturing unit. A processing unit is provided to process a fingerprint image captured by the fingerprint image capturing unit to capture a minutiae data from the fingerprint image, and to output the minutiae data.

S12: Receiving the minutiae data through the Bluetooth fingerprint device and sending a verification request through an application device.

The application device has an application program, and the verification request includes the minutiae data and a verification request from the application program. The application device of the present invention includes but is not limited to a Smartphone with a Bluetooth transmission function.

S13: Receiving the verification request through the application control device, and sending another request to the fingerprint identification server to compare the minutiae data.

S14: Receiving the minutiae data from the fingerprint identification server and comparing the minutiae data with the pre-stored fingerprint template data. If the compared data are matched, then go to S15. In S15, the application control device accepts the verification request from the application device, and the application control device agrees the application device to access data. If the compared data are not matched, return to Step S11 or enter into Step S16. In S16, the application control device refuses the verification request of the application device, and the application device may have a partial data access right.

The fingerprint identification server as described in Step 14 comprises a random access memory unit for storing N fingerprint template data, and the fingerprint identification server compares the minutiae data with one of the N fingerprint template data to determine whether they are matched or not, and produces a result, wherein N is greater than or equal to 1.

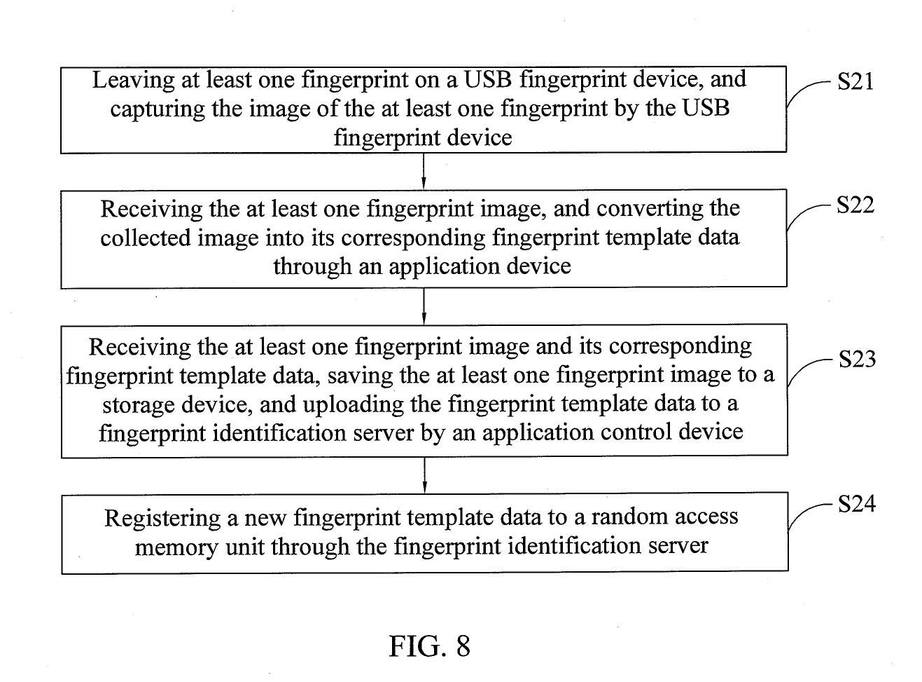

With reference to FIG. 8, which is a flow chart of a method of adding fingerprint template data of a fingerprint identification and verification system of the present invention, the method comprises the following steps:

S21: Leaving at least one fingerprint on a USB fingerprint device, and capturing the image of the at least one fingerprint by the USB fingerprint device.

S22: Receiving the at least one fingerprint image, and converting the collected image into its corresponding fingerprint template data through an application device.

S23: Receiving the at least one fingerprint image and its corresponding fingerprint template data, saving the at least one fingerprint image to a storage device, and uploading the fingerprint template data to a fingerprint identification server by an application control device.

S24: Registering a new fingerprint template data to a random access memory unit through the fingerprint identification server.

In summation of the description above, the fingerprint identification and verification system and the method thereof in accordance with the present invention adopts the Bluetooth fingerprint device to capture the minutiae data of the fingerprint image with limited hardware resources and transmits the minutiae data to the Smartphone. The minutiae data, rather than the complete fingerprint image is transmitted in order to reduce the data transmission time. The fingerprint identification server of a far-end system is provided to compare the minutiae data with the fingerprint template data pre-stored in the random access memory unit instead of retrieving the fingerprint template data from the fingerprint database for comparison. Therefore, this invention can effectively enhance the speed of identity verification.

What is claimed is:

1. A fingerprint identification and verification system, comprising:
a Bluetooth fingerprint device, including a processing unit and a fingerprint image capturing unit, and the processing unit processing a fingerprint image from the fingerprint image capturing unit to capture a minutiae data of the fingerprint image and producing the minutiae data;
an application device, having an application program, the application device receiving the minutiae data through the Bluetooth fingerprint device and sending a verification request, the verification request including the minutiae data and the verification request from the application program;
a fingerprint identification server, including a random access memory unit, and the random access memory unit storing N fingerprint template data, and while the fingerprint identification server receiving the minutiae data of the verification request, the fingerprint identification server comparing the minutiae data with one of the N fingerprint template data to determine whether the two are matched, and producing a verification result, wherein N is greater than or equal to 1; and
an application control device, receiving the verification result, and accepting or refusing the verification request from the application program according to the verification result.

2. The fingerprint identification and verification system of claim 1, further comprising a data storage device electrically coupled to the application control device, the data storage device backing up the N fingerprint template data.

3. The fingerprint identification and verification system of claim 2, further comprising a cable-transmission fingerprint device, and the cable-transmission fingerprint device further comprising a fingerprint image capturing unit, the fingerprint capturing unit capturing at least one fingerprint image, and transmitting the at least one fingerprint image to the application device, the application device receiving the at least one fingerprint image and converting the at least one fingerprint image into the (N+1)th fingerprint template data, and the fingerprint identification server receiving the (N+1)th fingerprint template data and registering the (N+1)th fingerprint template data to the random access memory unit.

4. The fingerprint identification and verification system of claim 3, wherein the application control device receives the at least one fingerprint image and the (N+1)th fingerprint template data corresponding to the at least one fingerprint image and backs up the at least one fingerprint image and the (N+1)th fingerprint template data corresponding to the at least one fingerprint image to the data storage device.

5. The fingerprint identification and verification system of claim 1, further comprising a cable-transmission fingerprint device, and the cable-transmission fingerprint device further comprising a processing unit and a fingerprint image capturing unit, and the processing unit processing a fingerprint image captured by the fingerprint image capturing unit to capture a minutiae data of the fingerprint image, producing the minutiae data, and transmitting the minutiae data to the application device.

6. A fingerprint identification and verification method, comprising:
using a Bluetooth fingerprint device to capture a fingerprint image and producing a minutiae data, the Bluetooth fingerprint device comprising a processing unit and a fingerprint image capturing unit, and the processing unit processing the fingerprint image captured by the fingerprint image capturing unit to capture the minutiae data of the fingerprint image, and producing the minutiae data;
using an application device to receive the minutiae data through the Bluetooth fingerprint device and sending a verification request, the application device having an application program, and the verification request including the minutiae data and the verification request from the application program;
using a fingerprint identification server to receive the minutiae data of the verification feature request, and using a random access memory unit of the fingerprint identification server to store N fingerprint template data, and the fingerprint identification server comparing the minutiae data with one of the N fingerprint template data to determine whether the two are matched, and producing a verification result, wherein N is greater than or equal to 1; and
using an application control device to receive the verification result and accept or refuse the verification request from the application program according to the verification result.

7. The fingerprint identification and verification method of claim 6, further comprising:
using a data storage device to back up the N fingerprint template data.

8. The fingerprint identification and verification method of claim 7, further comprising:
using a cable-transmission fingerprint device to capture at least one fingerprint image; and
using the application device to receive the at least one fingerprint image and converting the at least one fingerprint image into the (N+1)th fingerprint template data, and the fingerprint identification server receiving the (N+1)th fingerprint template data, and registering the (N+1)th fingerprint template data to the random access memory unit.

9. The fingerprint identification and verification method of claim 8, further comprising:
using the application control device to receive the at least one fingerprint image and the (N+1)th fingerprint template data corresponding to the at least one fingerprint image, and backing up the at least one fingerprint image and the (N+1)th fingerprint template data corresponding to the at least one fingerprint image to the data storage device.

10. The fingerprint identification and verification method of claim 6, further comprising:
using a cable-transmission fingerprint device to capture the fingerprint image and producing the minutiae data, wherein the cable-transmission fingerprint device comprises a processing unit and a fingerprint image capturing unit, and the processing unit processes the fingerprint image captured by the fingerprint image capturing unit to capture the minutiae data of the fingerprint image, producing the minutiae data, and transmitting the minutiae data to the application device.
